(19) United States
(12) Patent Application Publication
(10) Pub. No.: US 2008/0040488 A1
(43) Pub. Date: Feb. 14, 2008

(54) CONTEXT-AWARE MOBILE PORTAL

(75) Inventors: Puneet Gupta, Bangalore (IN); Karthik G V, Karaikal (IN); Kavitha Damodhiran, Coimbatore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 11/835,996

(22) Filed: Aug. 8, 2007

(30) Foreign Application Priority Data
Aug. 9, 2006 (IN) 1425/CHE/2006

(51) Int. Cl. G06F 15/16

(52) U.S. Cl. 709/227

(57) ABSTRACT

Middleware interposed between a mobile client device and a server can limit rendered online services to those appropriate to a context for the mobile client device. For example, characteristics of the mobile client device, the type of connection, and the like can be taken into account when deciding which online services to render at the mobile client device. Useful for avoiding presentation of online services that are inappropriate, incompatible, or the like.

### BACKGROUND

Mobile computing has become pervasive in modern society. For example, mobile devices now provide the opportunity to access a wide variety of services and can be carried almost anywhere. Content providers see mobile devices as a growing market opportunity with limitless potential.

However, current approaches to mobile computing can be less than optimal. For example, a mobile user may select a service for execution at the mobile device, only to find that it does not function on the device. Or, the user may have to choose from a lengthy list of device types before being presented with services appropriate for the device. In either case, the user can be wasting connect time that could be better used on other activities.

Therefore, there still remains need for technologies to address shortcomings of current mobile device approaches.

### SUMMARY

A variety of techniques can be used for supporting a context-aware approach to providing online services. As described herein, a middleware service can receive a general request from a client device for online services and respond with a list of only those online services deemed appropriate, based on a current context of the client device.

A wide variety of parameters can be supported as part of the context, providing a rich context by which a wide variety of customization for different devices, users, and situations can be supported.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system comprising a middleware service that provides indications of online services available to a mobile client device from one or more servers.

FIG. 2 is a flowchart of an exemplary method of processing a request for services from a mobile client device and can be implemented in a middleware service such as that shown in FIG. 1.

FIG. 3 is a flowchart of an exemplary method of processing a general request for services that comprises sending indications of context-appropriate services to a mobile client device.

FIG. 4 is a diagram of exemplary context parameters within a current context for a mobile client device.

FIG. 5 is a block diagram of an exemplary system comprising a configurable middleware service that sends indications of context-appropriate services to a mobile client device according to a context for the mobile client device.

FIG. 6 is a flowchart of an exemplary method of processing a request from a mobile client device based on the context of the mobile client device.

FIG. 7 is a flowchart of an exemplary method of filtering services via current context of a mobile client device.

FIG. 8 is a screen shot of an exemplary user interface presented by a mobile client device as a result of processing by the technologies described herein to determine context-appropriate services, for which links are displayed.

FIG. 9 is a block diagram of exemplary context-appropriate services displayed for different mobile client devices of different device types.

FIG. 10 is a block diagram of an exemplary context-aware mobile portal and categories of services available from the portal via navigation to pages that can be rendered at the mobile client device.

FIG. 11 is a screen shot of an exemplary user interface presented by a mobile client device for configuring location, which can be reflected in the context of the mobile client device.

FIG. 12 is a flowchart of an exemplary method of processing location for inclusion in a current context of a mobile client device.

FIG. 13 is a screen shot of an exemplary user interface presented by a mobile client device for providing context-appropriate schedules.

FIG. 14 is a block diagram of an exemplary data structure for storing online service definitions by which services can be filtered based on their execution requirements.

FIGS. 15, 16, and 17 show exemplary extensible markup language (XML) illustrating an exemplary schema for defining online services and their execution requirements.

FIG. 18 is a block diagram of an exemplary suitable computing environment for implementing any of the technologies described herein.

### DETAILED DESCRIPTION

### Example 1

### Exemplary System Employing a Combination of the Technologies

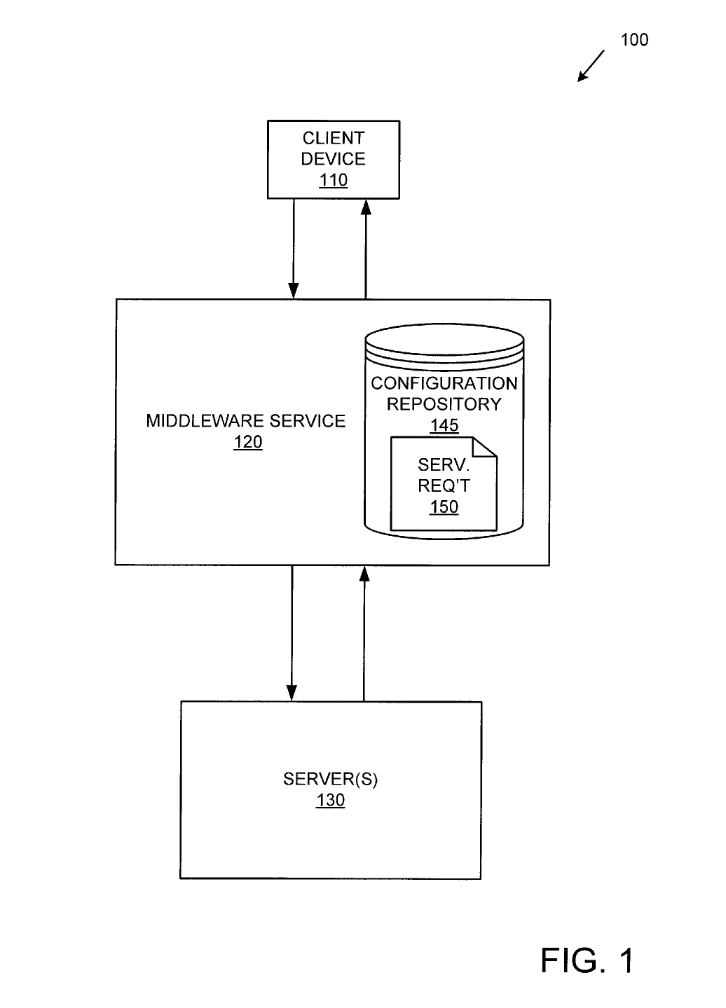

FIG. 1 is a block diagram of an exemplary system 100 comprising a middleware service 120 that provides indications of online services available to a mobile client device 110 from one or more servers 130. The system 100 and variants of it can be used to perform any of the methods described herein.

In the example, the system 100 includes a configuration repository 145 comprising one or more service requirements 150. For example, such a repository can be used to configure the middleware service 120. In some cases, configuration can be achieved without coding (e.g., without having to write or modify executable code). Instead, configuration can be achieved by a user interface presented by an administration console, editing configuration files (e.g., XML), adding to or editing the service requirements 150 or the like.

The example also shows one or more servers 130 which can process requests for specific online services that are received from the mobile client device 110 (e.g., directly or through the middleware service 120). As described herein, indications of the possible online services provided to the mobile client device 110 can be limited to those that are appropriate for the mobile client device, based on a current context for the mobile client device.

Although the configuration repository 145 is shown as part of the middleware service 120, any part or all of the configuration repository can be outside (e.g., but accessible by) the middleware service 120. For example, the services available via the servers 130 can be stored in a configuration repository at the servers 130.

In practice, the system 100 can be more complicated, with additional devices, online services, servers, repositories, and the like.

### Example 2

### Exemplary Perspectives

Although some of the examples assume the perspective of the middleware service 120, the methods described herein can be implemented from other perspectives (e.g., from the perspective of the mobile client device 110 or from the one or more servers 130). For example, although the terminology “receiving a request” is used from the perspective of the middleware service 120, such an act could also be described as “sending a request” from the perspective of the mobile client device 110.

### Example 3

### Exemplary Method Employing a Combination of the Technologies

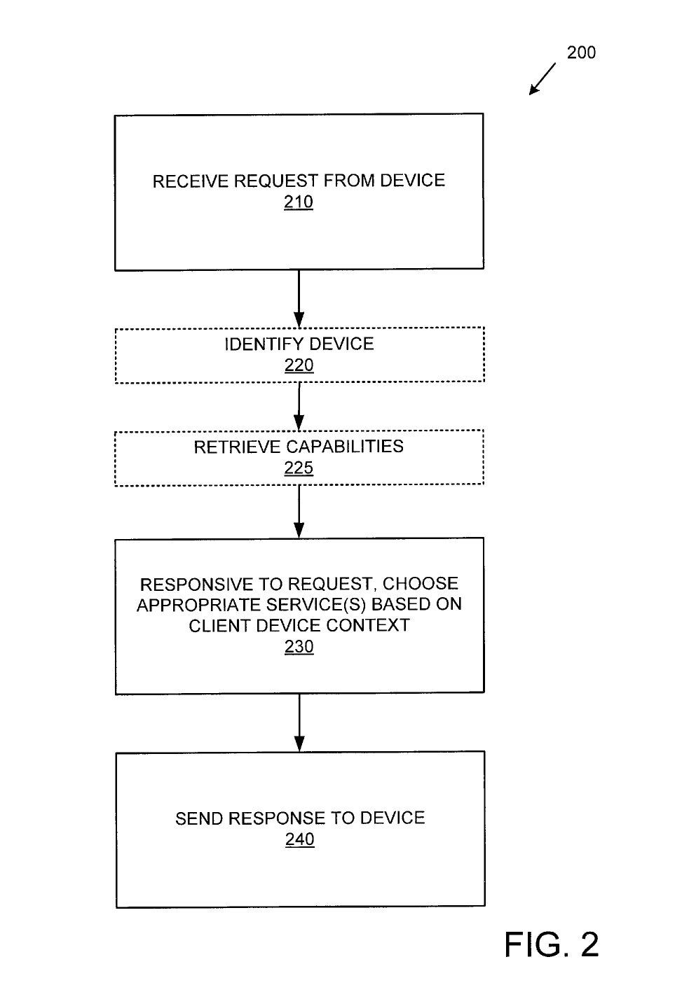

FIG. 2 is a flowchart of an exemplary method 200 of processing a request from a mobile client device and can be implemented in a middleware service such as that shown in FIG. 1. At 210, a request is received from a client device. For example, a general request for services can be received in the form of a Uniform Resource Locator or other indication of a network location.

At 220, the client device is identified. For example, the type of client device can be identified, or some other identifier can be used. At 225, capabilities are retrieved (e.g., from a repository). As described herein, such capabilities can include device capabilities, browser capabilities, and other custom attributes available via the repository. The actions are shown in dotted boxes because they need not be performed each time a request is received. Instead, the device identity or some indication of it can be stored for reuse later (e.g., via a session mechanism).

At 230, responsive to the request from the mobile client device, one or more appropriate services are chosen based on the mobile client device context. Such an action can rely on a configuration repository as described herein.

At 240, a response is sent to the client device. The response can include indications of the one or more appropriate online services which are rendered on the client device as a user interface presentation (e.g., on a display of the client device). The user can subsequently activate the indication with the mobile client device to access the respective online service.

The method 200 and any of the methods described herein can be performed by computer-executable instructions stored in one or more computer-readable media (e.g., storage or other tangible media).

### Example 4

### Exemplary Online Service Request Processing Comprising Filtering for Client Device Context

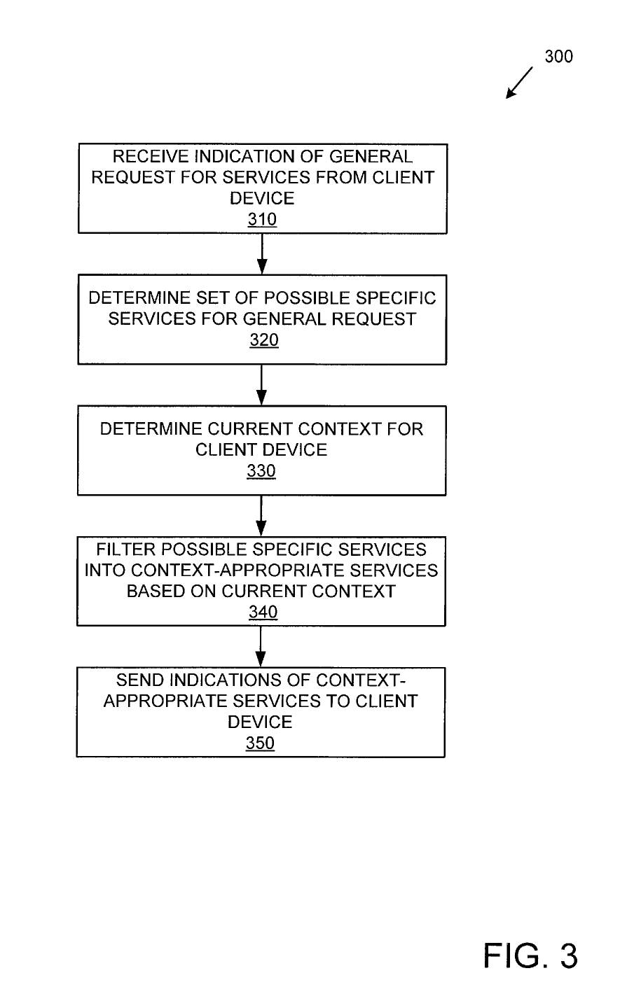

FIG. 3 is a flowchart of an exemplary method 300 of processing a request that comprises filtering a set of possible specific online services into context-appropriate online services based on current context of a mobile client device. At 310, an indication of a general request for online services is received from a client device. For example, a user can indicate the general request by activating a user interface element (e.g., a graphical button, a hyperlink, or the like), visiting a web address (e.g., via an URL), or the like with a mobile client device. As a result, an indication of the general request is sent to the middleware service.

At 320, based on a configuration repository, and responsive to receiving the indication of the general request, the set of possible specific online services for the general request is determined. For example, a list of the possible online services can be stored and associated with the general request. Such a list can be retrieved from a local location (e.g., at a middleware service) or a remote location (e.g., at servers providing the services or elsewhere).

At 330, the current context for the mobile client device is determined. Current context can include any of the context parameters described herein. The current context can be stored as part of a session mechanism or determined anew upon receipt of a general request for online services.

At 340, the possible specific online services are filtered into one or more context-appropriate online services based on a current context of the mobile client device. In practice, the resulting online services will be a proper subset of the possible specific services. For example, if the current context indicates that the client device does not meet execution requirements of an online service, the online service is not included in the list of context-appropriate services. Similarly, any indication in the current context that does not meet the requirements of the online service can cause the service to not be included in the list.

At 350, indications of the context-appropriate online services are sent to the mobile client device as a response to the general request for online services. The response can then be rendered by the client device as a user interface presentation from which the user can select a desired service out of those indicated.

In this way, the online services provided for selection by the user can be limited to those appropriate for the context (e.g., device capabilities or other context parameters).

### Example 5

### Exemplary Mobile Client Device

In any of the examples herein, a mobile client device can take the form of a mobile electronic device that can generate a request for processing and receive a response to the request. Responsive to the response, a user interface presentation can be presented on a display of the client device.

For example, a client device can be any mobile computer, mobile computing device, phone, pager, personal digital assistant, or the like. Although the technologies herein can also be employed in fixed devices, they can be applied with particular advantage to mobile (e.g., wireless) devices because there is wide diversity among such devices in terms of user interface and other features supported. For example, any device which can wirelessly access a communications network (e.g., the internet, a private network, a common carrier network, cellular network, or the like) can be used as a mobile client device which can send general requests via the network.

In practice, such devices are typically equipped with browsers that are capable of presenting a user interface, accepting user input (e.g., parameters), and sending the user input over the network.

### Example 6

### Exemplary Middleware Service

In any of the examples herein, a middleware service can serve as a liaison between a client device and one or more servers. The middleware service can be provided by one or more computing devices (e.g., general purpose programmable computers) that implement the technologies described herein. The middleware service can accept a request (e.g., via a wireless technique), and then send a response indicating context-appropriate online services available to the client device (e.g., via a wireless technique) from the one or more services. In practice, the middleware service can support a variety of protocols (e.g., HTTP, WAP, and the like) in order to be accessible by a variety of client devices. Similarly, the middleware service can support services accessed via a variety of ways (e.g., via HTTP or other protocols).

### Example 7

### Exemplary Online Services

In any of the examples herein, a variety of online services (e.g., provided by one or more servers) can be indicated as available by the middleware service. For example, online services can include games, browsers, news, astrology, ringtones, themes, device or manufacturer specific applications, translations, dictionaries, instant message clients, readable documents (e.g., books, word processing, universally formatted documents, such as ADOBE ACROBAT documents, or the like), database downloads, applications, converters (e.g., entertainment, DVD to PPC, Movie Theater, and the like), help, transportation schedules, and the like.

Such online services can be provided via a software-as-a-service (SaaS) model, downloaded to the mobile client device for execution, or both. In practice, an online service can be selected by activating a user interface element in a user interface, visiting a network location (e.g., a uniform resource locator, web address, or the like), pressing a button on the mobile client device, or the like.

### Example 8

### Exemplary Indications of Online Services

In any of the examples herein, an indication of an online service can be any mechanism by which a user can select or activate the online service. For example, a user interface element can be presented in a user interface indicating a name or other indication of the service. Upon selection of activation by the user, the associated online service or further information by which the service can be selected or activated is provided.

In practice, an indication of an online service can be provided in markup or other language to a mobile client device in coded form. When rendered on the screen, the indication can take the form of a hyperlink, graphical pushbutton, image, or other activatable user interface element. The online service or further information about the online service can then be provided responsive to activation of the user interface element.

### Example 9

### Exemplary Server

In any of the examples herein, a server providing an online service can be any of a variety of computer servers. In practice, the server can access databases and other data sources to respond to the request for the online service. Mainframe, mini, or micro technology can be used.

In practice, although sometimes called a “server,” a plurality of server machines (e.g., in a server farm, load balancing, failover arrangement, or the like) can be used to process online service requests.

### Example 10

### Exemplary Context

In any of the examples herein, a context for a mobile client device can include any of a wide variety of parameters that can be used to filter online services into those appropriate for the current device, situation, or other variable. As described herein, context can include mobile client device hardware capabilities (e.g., memory, wireless (e.g., WiFi) capabilities, BLUETOOTH capability, display resolution, display colors, voice capability, camera capability, and the like), device software capabilities (e.g., operating system name, operating system version, browser name, browser version, browser capabilities (e.g., whether is supports scripting, styles, forms, layers, frames, tables, etc.), platform name, platform version, and the like), user preferences, user personalization (e.g., user history), network quality, physical characteristics (e.g., location, time, situation (e.g., outside or inside a building)), urgency (e.g., time-pressured), custom parameters (e.g., implied from past usage, such as whether user is in a particular location type such as railway station, bus stop, etc.), profile parameters (e.g., characteristics about the user), connectivity mechanism type (e.g., GPRS, GSM, CDMA, or the like) or any combination thereof.

A client device capability context can be constructed based on a standard device context based on the type of client device. However, other characteristics and behaviors can be included for a non-standard device (e.g., a device that has been modified, enhanced, upgraded, or the like) in one or more custom device-specific contexts. For example, attributes or characteristics of the device can be determined via discovery techniques and the like.

The context for a client device can be an aggregated context of any of the contexts described herein.

Context can be extended in a variety of ways to provide a rich context that can accommodate a wide variety of scenarios responsive to user expectations.

### Example 11

### Exemplary Context Parameters

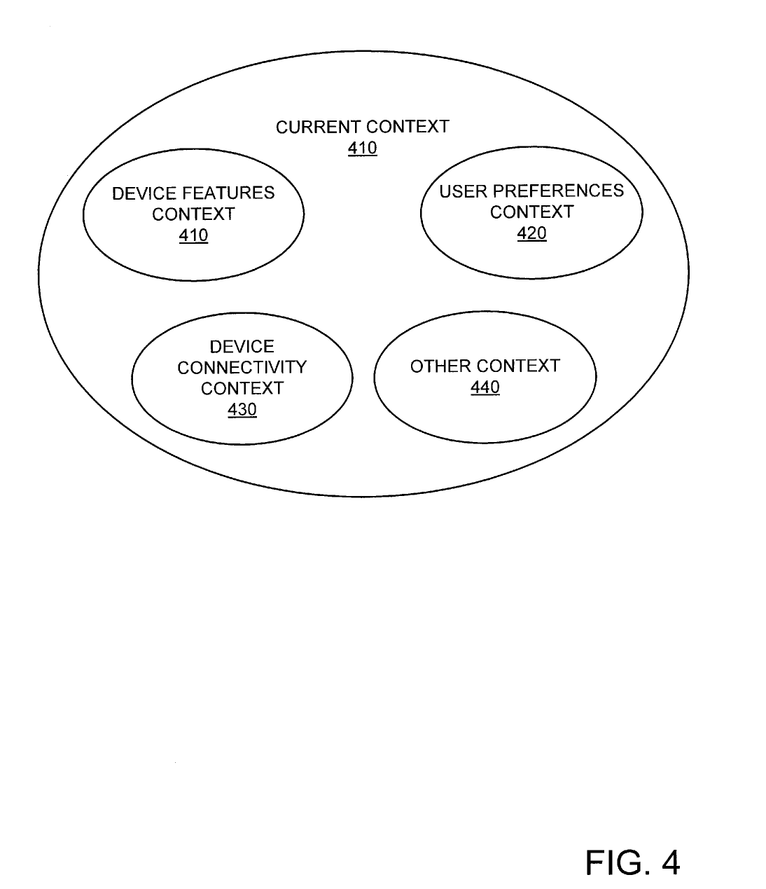

FIG. 4 is a diagram of exemplary context parameters within a current context 410 for a mobile client device. In the example, the current context 410 includes parameters indicating device features in a device features subcontext 410, parameters indicating user preferences in a user preferences subcontext 420, parameters indicating device connectivity in a device connectivity context 430, and other parameters in another subcontext 440. A rich set of parameters can be provided, resulting in flexibility and adaptability of the context and determining context-appropriate online services.

### Example 12

### Exemplary User Interface Context

In any of the examples herein, a user interface context can indicate the user interface capabilities of the device in question. For example, such capabilities can include screen real estate (e.g., screen size), whether various user interface elements (e.g., images) are supported, whether certain languages are supported, and the like.

### Example 13

### Exemplary Client Device Capability Context

In any of the examples herein, the context for a client device can indicate the capabilities of the device in question. For example, such capabilities can include user interface capabilities, the browser, whether certain languages (e.g., Java, and the like) are supported, whether certain security features are supported, what input mechanism is supported, deck size, quality of service (e.g., bandwidth) and the like.

The client device context can include the user interface context for the device.

The middleware service can identify the device type (e.g., via analyzing incoming requests) and can also identify other information (e.g., form factors). A queryable device capability repository can store the capabilities for many (e.g., hundreds and growing) devices.

### Example 14

### Exemplary User Profiles

In any of the examples herein, parameters from a user profile can be included in the context. For example, a profile indicating the age and personal tastes of the user (e.g., favorite game types, favorite music, favorite art, or the like) can be consulted to construct the current context of the mobile client device.

### Example 15

### Exemplary Client Device Capability Repository

In any of the examples herein, the capabilities of various client devices can be stored in a repository. So that information remains current, it can be retrieved from a service (e.g., in a Service Oriented Architecture or web service arrangement).

Information for common devices can be stored locally to reduce latency.

The repository can indicate the capabilities of a device based on the type of the client device.

### Example 16

### Exemplary Online Services Appropriate for Context

In any of the examples herein, online services can be chosen as appropriate based on context. In practice, an appropriate online service can be chosen based on parameters related to the context. For example, if an online service is indicated (e.g., in a configuration repository) as appropriate for outdoor users, and the context indicates that the user is outdoors, the online service is appropriate for the current context.

Sometimes, the appropriate service is said to “match” the context. In practice, appropriate online services can be chosen by filtering out those that have requirements not indicated in the current context. However, appropriate online services can also be determined by finding those that are supported by the current context.

Thus, selecting those online services appropriate for the current context can comprise omitting online services incompatible with the device capabilities of the mobile client device as indicated by the current context and including online services compatible with the device capabilities of the mobile client device as indicated by the current context. Any of the other context parameters described herein can also be used when selecting appropriate online services

A configuration repository can indicate the online services and their requirements, and the current context can be consulted to determine whether it meets the specified requirement for a respective online service.

### Example 17

### Exemplary General Request

In any of the examples herein, a general request for online services can be any indication of a general request for online services. In practice, such a request can take the form of a uniform resource locator (URL) or other HTTP requests, but other formats or protocols can be used. The general request can be a request for all online services, services related to a particular category of online service, or the like. For example, those online services provided by a particular vendor or other provider can be involved.

The request can be initiated at the client device by visiting an URL (e.g., of a portal website or a web page), activating a displayed hyperlink, pressing a virtual button, submitting a virtual fillable form, or the like.

As described herein, a request can be sent to the middleware service, which responds with indications of context-appropriate services that can be selected at the mobile client device by the user.

### Example 18

### Exemplary Response

In any of the examples herein, a response can be any information sent in response to a request. A response can include indications of context-appropriate services as determined via the technologies described herein.

The response can be tailored for display on the client device so that it takes the form of a renderable user interface presentation. When received, the client device can then render the user interface presentation on a visual display screen (e.g., of the client device). The response can include interface elements by which the online services can be selected for access.

### Example 19

### Exemplary Online Service Requirements

In any of the examples herein, a service can have associated requirements indicating whether the service is appropriate for a particular current context. Such requirements are sometimes called “execution requirements” because they can specify the requirements for the service to execute properly (e.g., hardware capabilities of a device, software capabilities of a device, or the like). In practice, the requirements can also include parameters related to user preferences or other context parameters.

The requirements can be stored in the form of a database or configuration file, such as XML or some other markup or modeling language.

Although shown as a single file in some of the examples, a repository for indicating service requirements can be distributed throughout different files.

### Example 20

### Exemplary User Preferences

In any of the examples herein, parameters related to user preferences can be included as part of a current mobile client device context. Accordingly, such parameters can also be included as online service requirements.

For example, a user can specify that no graphics are desired, that only content in a particular language be presented, or the like. A configuration mechanism can be provided to the user by which preferences can be specified.

### Example 21

### Exemplary Rendering

In any of the examples herein, indications of online services can be rendered for presentation at a user interface of a mobile client device. Typically, such a user interface can include visible user interface elements such as text, passwords, numbers, number-only passwords, options (e.g., dropdown, popup, comboboxes, and the like), radio buttons, checkboxes, hyperlinks, displayed fields, editable displayed fields, dates, tables, graphical buttons, graphics, drop down menus, and the like. Audio elements such as sounds or music can be included.

A renderable user interface presentation can take the form of a markup language such as HTML, WML, or the like and can also include executable code such as Java, JavaScript, or the like. When rendered, the renderable user interface presentation takes the form of a user interface presentation (e.g., displayed on a client device).

Some user interface elements can be activated by a user (e.g., pressed, checked, clicked, or the like) to denote desired values, parameters, options, actions, or the like.

### Example 22

### Exemplary Session Functionality

In any of the examples herein, session information for a communications session can be stored and managed to maintain state for the communications session. For example, such information can include one or more of the following: client device type, client device capabilities, cached information, a unique session key, user settings, or the like. The information can be stored in a session data structure.

Other information (e.g., values of variables, parameters, or the like) can also be stored as part of a session and drawn upon when the middleware service serves as a liaison between the client device and the servers providing online services.

### Example 23

### Exemplary Implementation

### System

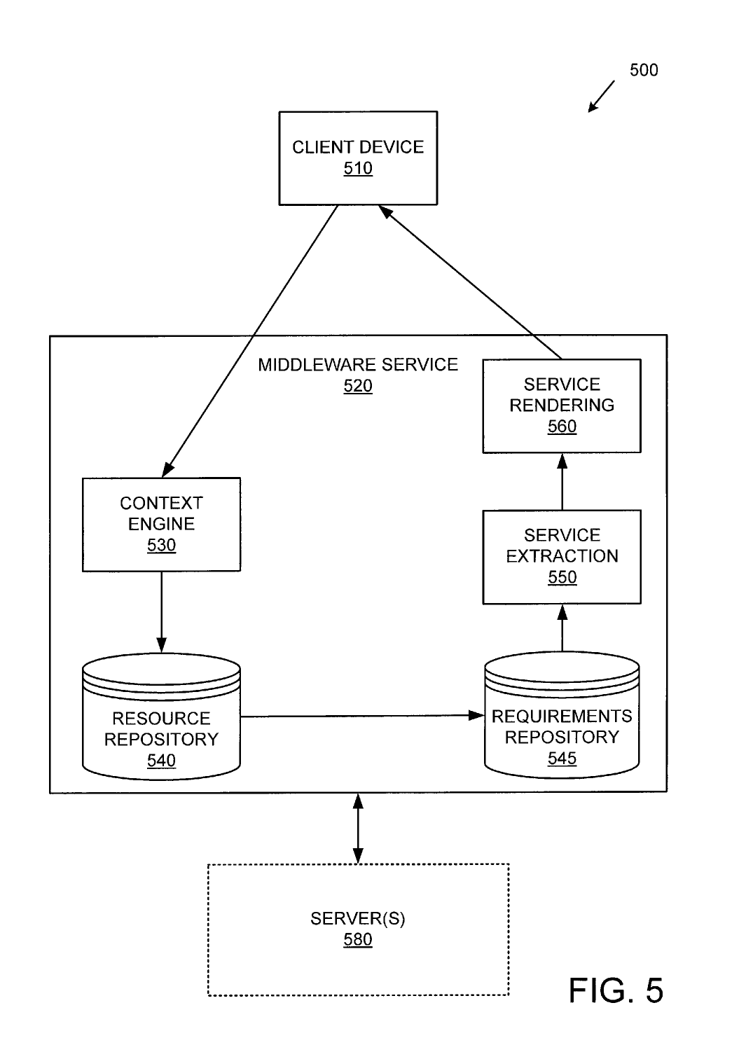

FIG. 5 is a block diagram of an exemplary system 500 comprising a configurable middleware service 520 that sends indications of context-appropriate services (e.g., available from one or more servers 580) to a mobile client device 510 according to a context for the mobile client device. In the example, the middleware service 520 comprises the following modules: a context engine 530, a resource repository 540, a requirements repository 545, a service extraction module 550, and a service rendering module 560. Although some of the modules are shown as databases, they can be implemented as modules that consult databases to process input and provide output.

The context engine 530 can be configured to analyze the incoming request (e.g., the request header), identify device capabilities, and obtain the device capabilities (e.g., load them into the current context). The request header or other information can be consulted to determine the device type, the device capabilities, or both. Additional context parameters can also be determined.

The resource repository 540 can be configured to identify the services offered by the servers 580 and load them (e.g., find indications of their names, locations, and the like).

The requirements repository 545 can be configured to identify device execution requirements for the respective services offered by the servers 580.

The service extraction module 550 can be configured to compare the device capabilities against the execution requirements for the respective services and place the matching entries into a results file (e.g., an XML file).

The service rendering module 560 can be configured to read the results file and convert it into a renderable markup language. If desired, a mobile framework can be used such as that described in Gupta et al., U.S. patent application Ser. No. 11/670,918, “Context-Aware Middleware Platform for Client Devices,” which is hereby incorporated herein by reference.

### Example 24

### Exemplary Implementation

### Method

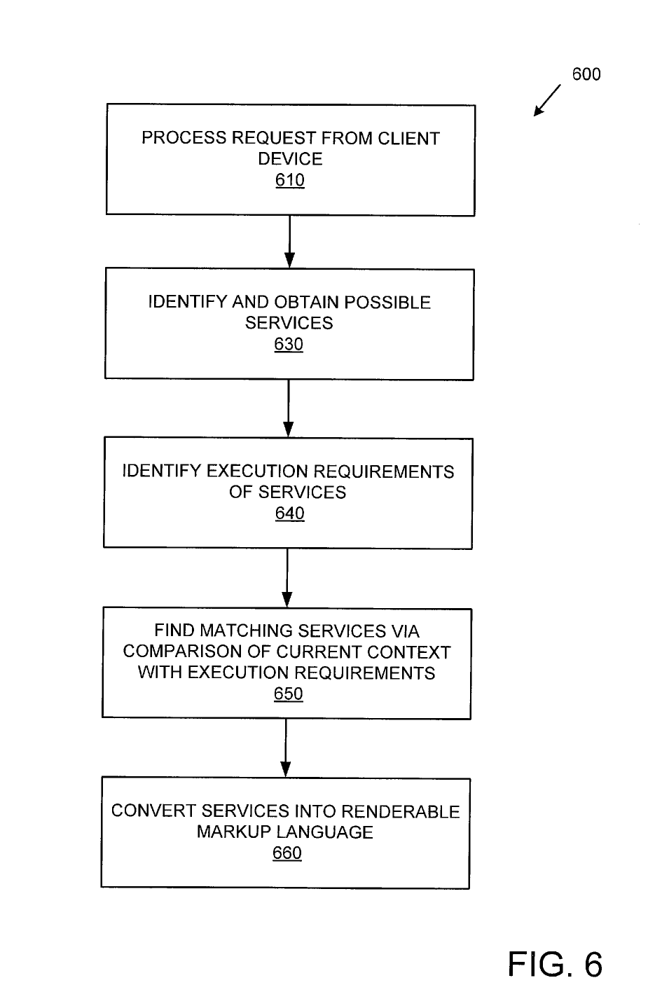

FIG. 6 is a flowchart of an exemplary method 600 of processing a request from a mobile client device based on the context of the mobile client device.

At 610, a general request for services from a mobile client device is processed. For example, the request header can be analyzed, device capabilities can be identified, and the device capabilities can be obtained (e.g., loaded into the current context). Any of the other context parameters described herein can be loaded into the current context (e.g., user preferences, location, and the like).

At 630, the possible services are identified and obtained (e.g., indications of the services' names, locations, and the like are found).

At 640, the device execution requirements for the respective services offered by the servers are identified.

At 650, matching services are found via a comparison of current context with execution requirements. The resulting services are those appropriate for the current context.

At 660, the indications of the services are converted into a renderable markup language, which is provided to the mobile client device as a response to the request.

### Example 25

### Exemplary Filtering

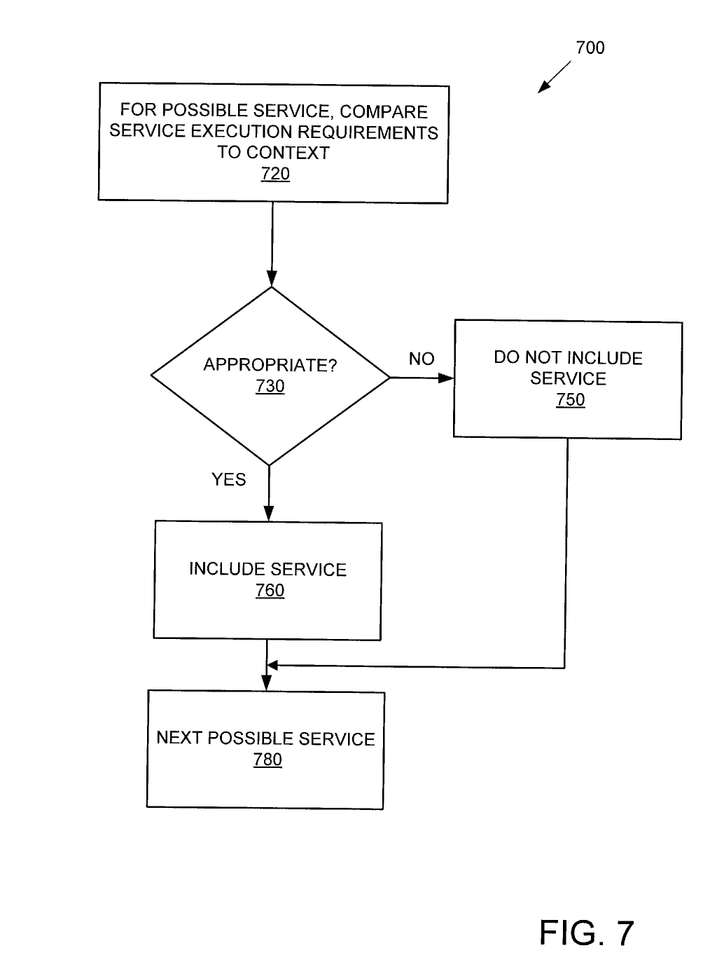

FIG. 7 is a flowchart of an exemplary method 700 of filtering services via current context of a mobile client device and can be used in any of the examples herein for determining which online services are appropriate for a context.

At 720, for a possible online service, the online service's execution requirements are compared to the current context.

At 730, it is determined whether the online service is appropriate for the context. For example, parameters indicated in the current context can be compared against the requirements to see if the current context's parameters are sufficient (e.g., match, fall within a range, or the like). If the service is not appropriate, at 750, the service is not included in the list of context-appropriate services. Otherwise, if the service is appropriate, at 760, the service is included in the list of context-appropriate services. In practice, the list can take the form of a list of indications of the services (e.g., XML, or other format)

The next possible service, if any, is considered at 780.

### Example 26

### Exemplary Context Parameters

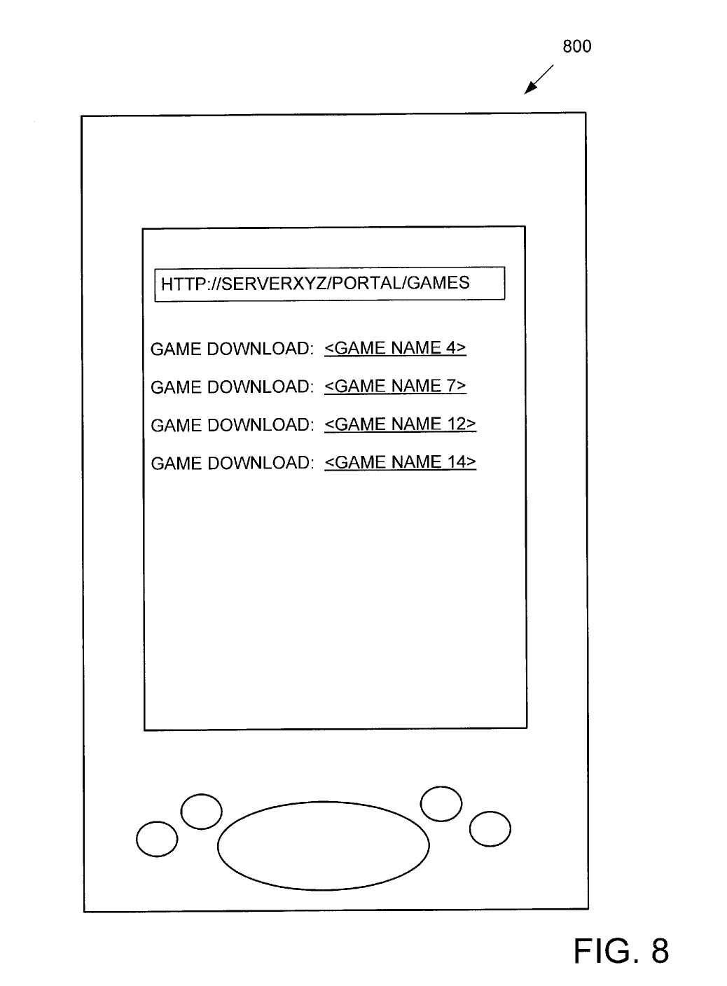

FIG. 8 is a screen shot 800 of an exemplary user interface presented by a mobile client device as a result of processing by the technologies described herein to determine context-appropriate services, for which links are displayed.

In the example, a user has navigated to a uniform resource locator that serves as an indication of a general request for services related to the game category. In response, the middleware service has provided indications of four games that are appropriate for the current context (e.g., can be executed in light of the hardware and software on the mobile client device).

Upon selection of one of the links, the game can be downloaded to the device, and the game can be played. Alternatively, the game can be provided as a service without having to download, or a client can be downloaded for an online game.

### Example 27

### Exemplary Different Services for Different Device Types

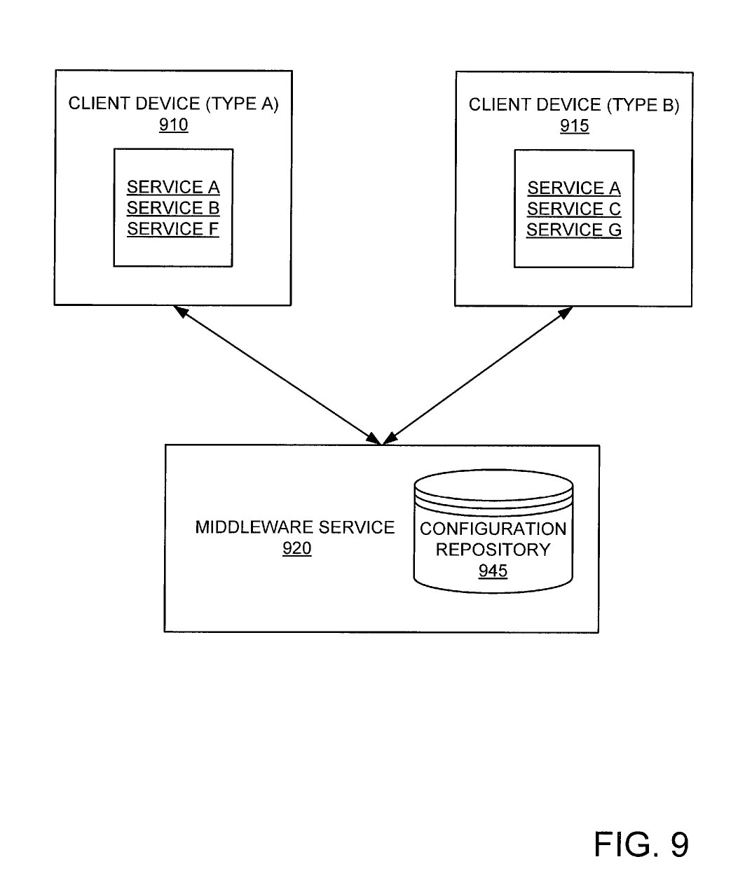

FIG. 9 is a block diagram of exemplary context-appropriate services displayed for different mobile client devices of different device types. Because context can include device capabilities in any of the examples herein, a request by two devices 910, 915 of different device types can result in display of a different list of services on the respective device.

The middleware service 920 can consult a configuration repository 945, which can indicate which services are appropriate for which device capabilities. Even if the remaining context parameters are the same (e.g., the same user preferences, connection, and the like), the device capabilities can cause different services to appear.

In this way, the technologies described herein can avoid displaying an online service for selection when the online service is not appropriate (e.g., will not execute on) a device of a particular type.

### Example 28

### Exemplary Portal Organization

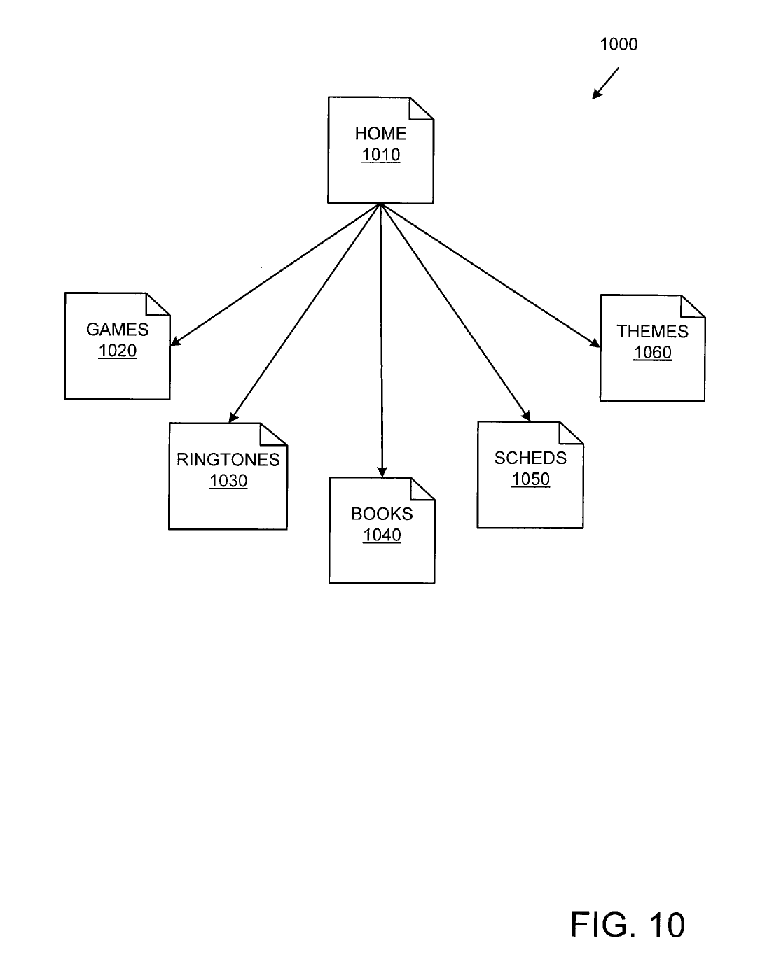

FIG. 10 is a block diagram of an exemplary context-aware mobile portal 1000 and categories of services available from the portal via navigation to pages that can be rendered at the mobile client device. In practice, the portal 1000 can include more or fewer pages of different or additional categories.

In the example, a home page 1010 allows navigation to category pages 1020, 1030, 1040, 1050, 1060 that serve as general requests for services of respective categories. For example, the home page 1010 can include hyperlinks to the respective category pages. The category pages are considered dynamic in that their apparent content will change based on the current context of the mobile client device. For example, two different devices visiting the pages can see two different lists of appropriate online services. Or, the same device visiting at different times can see two different lists of appropriate online services.

Alternatively, the portal can be dedicated to a single category of online services (e.g., games). If desired, such a portal can have sub-categories (e.g., types of games).

### Example 29

### Exemplary Implementation of Location Context

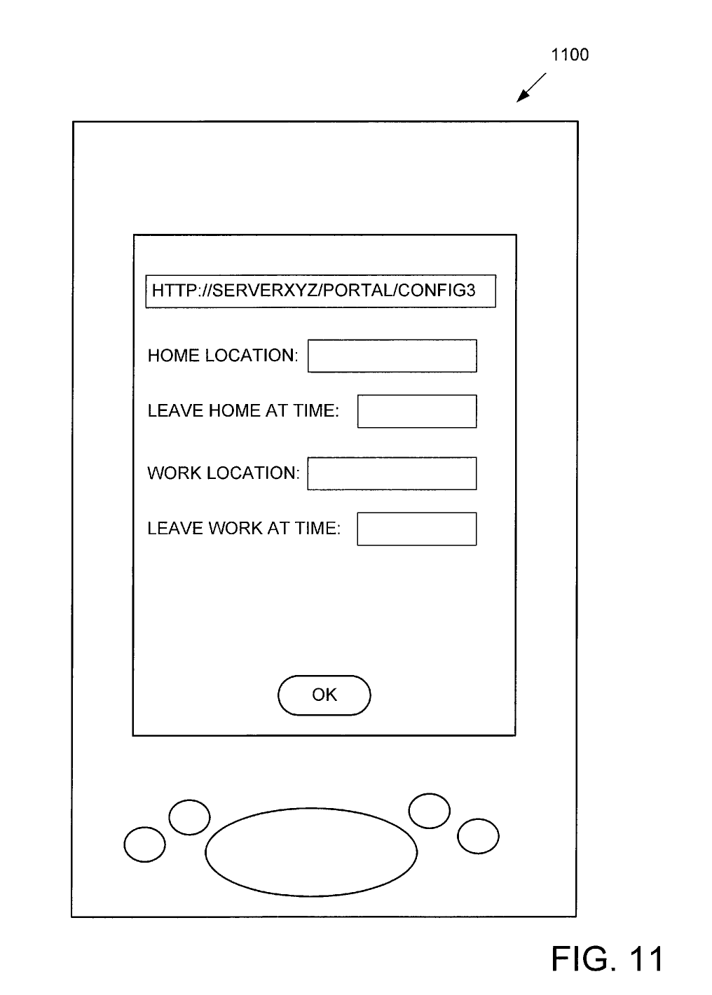

FIG. 11 is a screen shot 1100 of an exemplary user interface presented by a mobile client device for configuration location, which can be reflected in the context of the mobile client device. In the example, the device is visiting a uniform resource locator for configuring location.

The user can indicate a home location (e.g., via name, GPS coordinates, nearby wireless network, or the like) and a location at which the user leaves home. Similarly, a work location and time can also be indicated.

Consequently, when determining the current context of the device, a parameter indicating whether the user is at home or work can be included in the context. Accordingly, when visiting a portal, the portal can provide those services appropriate for work or home.

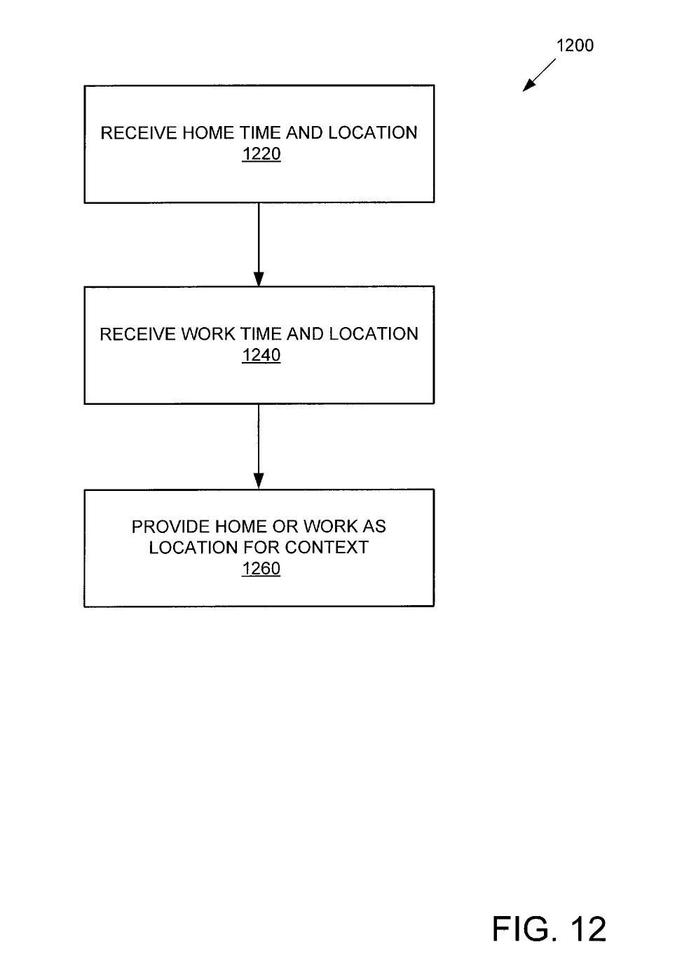

FIG. 12 is a flowchart of an exemplary method 1200 of processing location for inclusion in a current context of a mobile client device and can be used in any of the examples herein.

At 1220, the home time and location are received.

At 1240, the work time and location are received.

At 1260, “home” or “work” is provided as a parameter to indicate current location as part of the mobile client device context.

### Example 30

### Exemplary Implementation Using Location Context

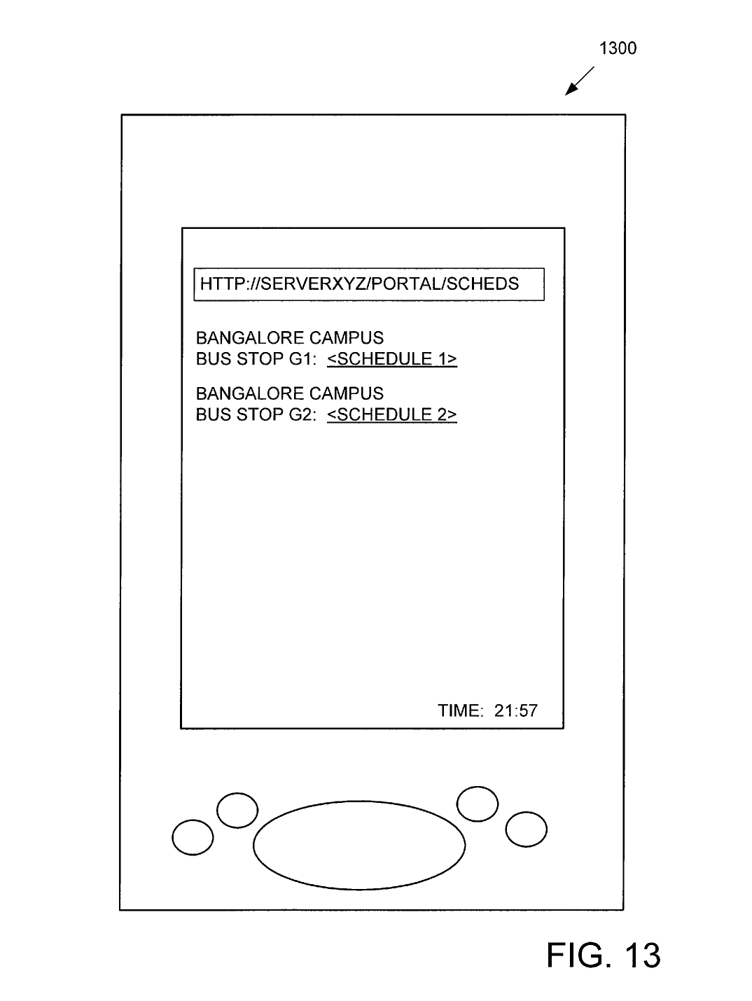

FIG. 13 is a screen shot 1300 of an exemplary user interface presented by a mobile client device for providing context-appropriate schedules (e.g., based on current location). Current location can be determined in a variety of ways. For example, the mechanism shown in FIG. 11 or 12 can be used. Also, a mobile device can have a built-in mechanism for determining location (e.g., based on GPS, nearest cell, nearest wireless network, or the like).

Based on the location, only those services appropriate for the location can be provided. In the example, selections for viewing the bus schedules at various bus stops on a local campus are provided. By selecting a displayed hyperlink, the bus schedule can be displayed on the screen on the mobile client device.

### Example 31

### Exemplary Online Service Definitions

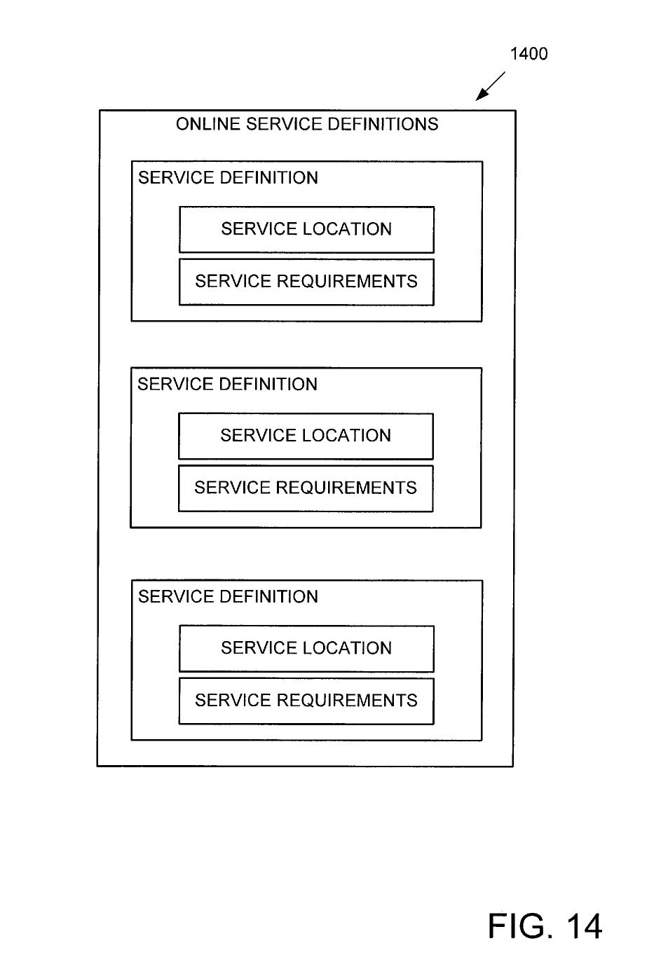

FIG. 14 is a block diagram of an exemplary data structure 1400 for storing online service definitions by which services can be filtered based on their execution requirements and can be used in any of the examples herein as a configuration repository.

In the example, a plurality of service definitions comprise respective service locations and service requirements. In practice, the service definitions can include a service name, service location, and the like. The service requirements can include those values of context parameters that indicate the service is appropriate for a particular context.

As described herein, the definitions can be implemented as a database, XML, or other format.

### Example 32

### Exemplary Advertising

The technologies described herein can also be used with advantage when applied to advertising. For example, an advertisement appropriate to the location and user profile of the mobile client device can be presented by filtering out advertisements that are not appropriate for the current context.

### Example 33

### Exemplary XML Defining Services and their Requirements

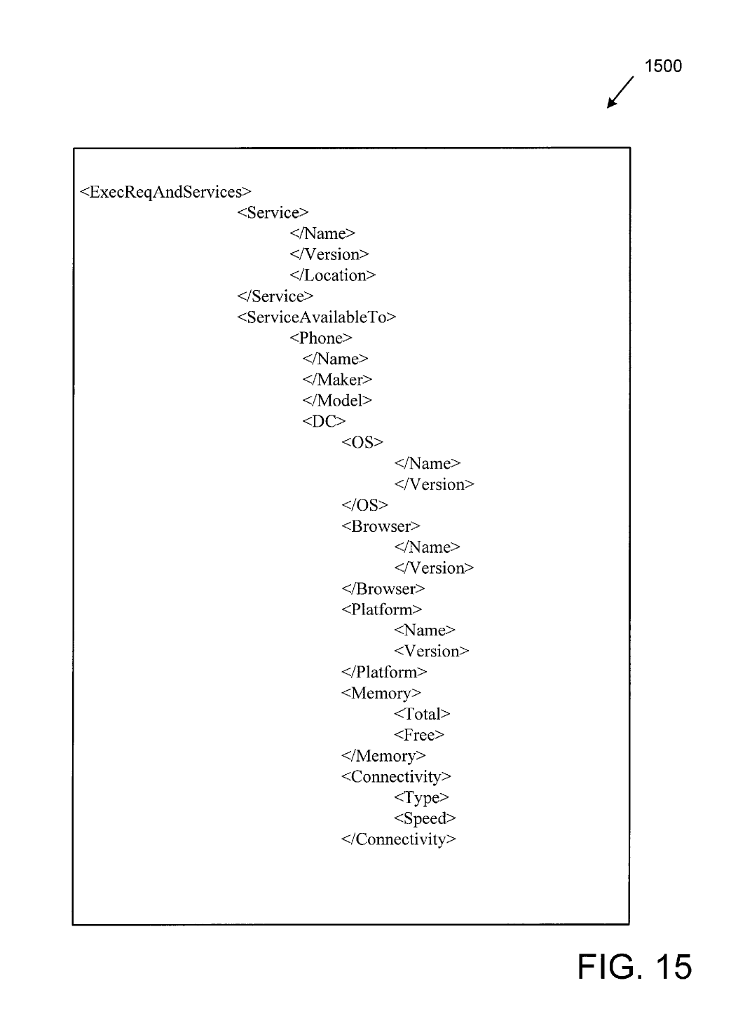

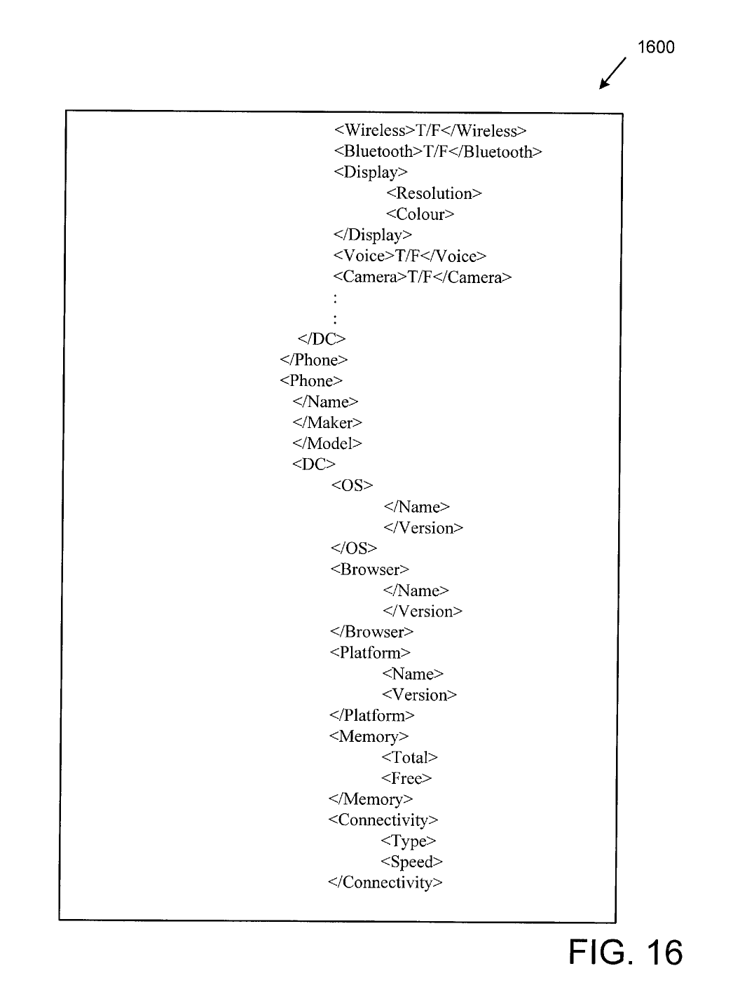

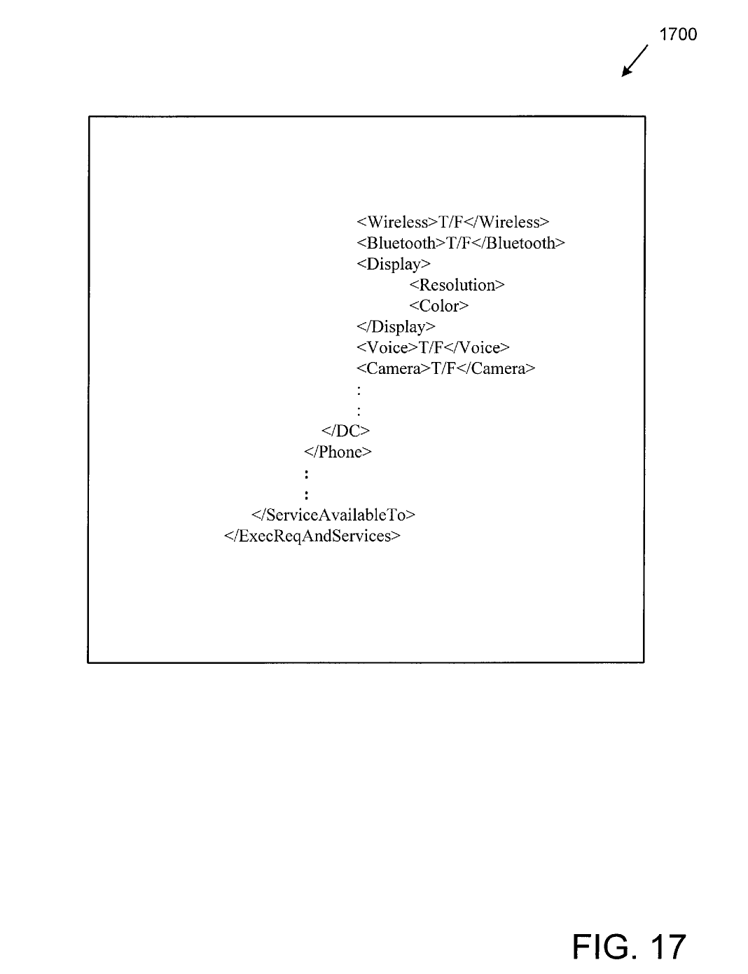

FIGS. 15, 16, and 17 show exemplary extensible markup language (XML) 1500, 1600, and 1700 illustrating an exemplary schema for defining online services and their execution requirements. In the example, a service can be given a name, version, and location. Following the service definition is an indication of the contexts to which the service is appropriate. The XML can be used with any of the technologies described herein when determining appropriate online services.

In the example, the contexts are indicated via phone (e.g., name, maker, and model) and a context for the device (e.g., operating system name and version, browser name and version, platform name and version, memory total and free, connectivity type and speed, whether wireless capability is present, whether BLUETOOTH capability is present, display resolution and color capability, whether voice capability is present, and whether a camera is present). Any number of contexts can be listed following the online service, any of which will be considered as appropriate.

### Example 34

### Exemplary Advantages

The technologies described herein can be used to avoid undesirable situations. For example, if a user wants to download a game from a website, a web page listing available games can be visited. The user can then choose the game to download and run. Then, a message may be shown later saying that the game cannot be installed on the device because the device is incompatible with the game.

Instead of a static listing of games, the technologies described herein can dynamically generate a list based on context (e.g., the capability of the device being used to access the service).

Another undesirable scenario is that the user can have a web page displayed asking to choose the device type by selecting the Original Equipment Manufacturer from a long (e.g., 15-20) list. After choosing the manufacture category is chosen, after another wait, the next page shows the long (e.g., 50) list of device models for the manufacturer. Finally, the user is shown a third page that allows downloading the game. While perhaps better than the earlier scenario, it is still not efficient, as a significant level of user interaction is required to complete a task such as downloading an application.

### Example 35

### Exemplary Advantages

The technologies described herein can provide the following:
Avoiding wasting money on the connection (e.g., the user is charged for each byte of data).
Avoiding wasting time on specifying the exact type of device to the service vendor
Avoiding wasting time by going through many pages to let the service vendor know the device type and browsing through the services
Saves network bandwidth
Avoids failure of the service (e.g., due to incompatibility)
Provides a seamless user experience
User can focus on the intended task (i.e., other aspects are transparently managed by the system)

### Example 36

### Exemplary Advantages

A mobile portal architecture as described herein can allow context-specific re-adjustments on accesses by a mobile user, thereby allowing seamless downloadable content delivery.

A seamless content delivery system can be based on the requesting device.

Download features can be reduced on the requesting device.

### Example 37

### Exemplary Uses

The technologies described herein can be used with any of a variety of devices. Such devices can be mobile or fixed devices configurable to work in a communication network. The communication network may be categorized as an ad-hoc communication network, a fixed communication network, or both.

Many types of communication networks can be used, such as local area networks (LANs), wherein the devices are geographically close together (e.g., in the same building). Another type of communication network is a wide-area network (WAN), wherein the devices are farther apart and are connected by telephone lines or radio waves. Another type of communication network is a campus area network (CAN), wherein the devices are within a limited geographic area, such as a campus or military base. A metropolitan area network (WAN) is possible and refers to a data network designed for a town or city. Global networks (e.g., the Internet) can be used, as can any network supporting Internet or Internet-like protocols.

As described herein, context can be defined as the device type the end user is using to access a service, the state of connectivity, as well as user preferences, among other things.

The technologies can help mobile users access and/or download installable items, news, books, and the like wirelessly using any of the connectivity mechanisms (GPRS, GSM, CDMA, or the like), seamlessly without requiring user intervention in terms of providing details such as device type, OEM, or the like. The technologies can greatly help the user in saving bandwidth, thereby saving money and time as well.

Current web sites dealing with mobile content tend to provide downloadable mobile content in a static manner, not giving much importance to device diversity in the consumer market. So, users or clients are forced to provide more details while they are downloading content from their site. With the technologies described herein, the user or client can be freed from providing unwanted details and thereby saving money, time, and network transmission. In sum, the user need focus only on the intended task (e.g., which application to download). Other tasks are transparently managed by the system.

For example, a mobile user who wishes to acquire a game can visit the web address of the site and is presented with a web page instantly with only the list of downloads supported by the device being used in a neat an legible format. The list can be in a neat and legible format that fits the device. The list can appear to be customized for the device. After clicking on the game of interest, the download happens without any problem of incompatibility.

### Example 38

### Exemplary Dynamic, Context-Aware Mobile Portal

Dynamic, context-aware mobile portal middleware can sit between the service provider and the mobile user. Whenever the user sends a request, it can be sent to the middleware and, after identifying the device capabilities, the middleware can talk to the service provider and find the services offered. Then, from the list of services, the middleware can extract those that are compatible with the device. It can then dynamically create a page in an appropriate format (e.g., HTML, XHTML, or the like) with the extracted service alone and sends the page to the user. Various actions happen behind the scenes pervasively and transparent to the user, and the user can be given a felling of instant and useful response.

### Example 39

### Exemplary Scenario

The technologies described herein can be used to implement a solution that avoids drawbacks mentioned herein. For example, a mobile user who wishes to acquire a game can access a web address with a client device (e.g., at a portal web site that houses a wide variety of software, utilities, and the like for a wide variety of different mobile devices). The user can be presented with a web page instantly with only the list of downloads (e.g., supported by the accessing device) in a neat and legible format (e.g., which fits the device). The same site can appear differently on devices of different types (e.g., it can be customized to the device type). The user can click on the game of interest, and the download happens without any problem of incompatibility.

### Example 40

### Exemplary Computing Environment

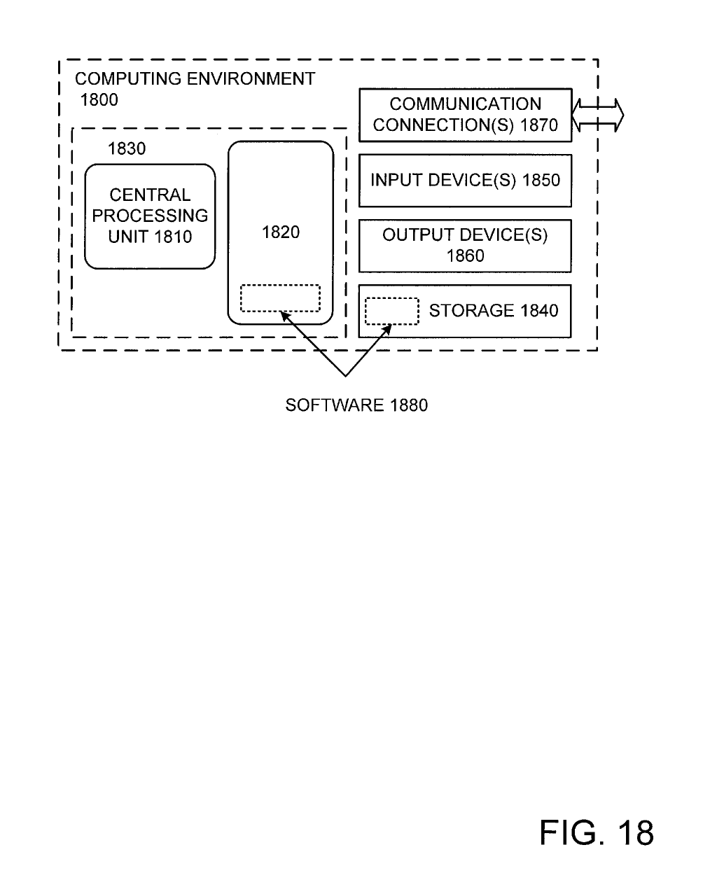

FIG. 18 illustrates a generalized example of a suitable computing environment 1800 in which the described techniques can be implemented. The computing environment 1800 is not intended to suggest any limitation as to scope of use or functionality, as the technologies may be implemented in diverse general-purpose or special-purpose computing environments. A mainframe environment will be different from that shown, but can also implement the technologies and can also have computer-readable media, one or more processors, and the like.

With reference to FIG. 18, the computing environment 1800 includes at least one processing unit 1810 and memory 1820. In FIG. 18, this most basic configuration 1830 is included within a dashed line. The processing unit 1810 executes computer-executable instructions and may be a real or a virtual processor. In a multi-processing system, multiple processing units execute computer-executable instructions to increase processing power. The memory 1820 may be volatile memory (e.g., registers, cache, RAM), non-volatile memory (e.g., ROM, EEPROM, flash memory, etc.), or some combination of the two. The memory 1820 can store software 1880 implementing any of the technologies described herein.

A computing environment may have additional features. For example, the computing environment 1800 includes storage 1840, one or more input devices 1850, one or more output devices 1860, and one or more communication connections 1870. An interconnection mechanism (not shown) such as a bus, controller, or network interconnects the components of the computing environment 1800. Typically, operating system software (not shown) provides an operating environment for other software executing in the computing environment 1800, and coordinates activities of the components of the computing environment 1800.

The storage 1840 may be removable or non-removable, and includes magnetic disks, magnetic tapes or cassettes, CD-ROMs, CD-RWs, DVDs, or any other computer-readable media which can be used to store information and which can be accessed within the computing environment 1800. The storage 1840 can store software 1880 containing instructions for any of the technologies described herein.

The input device(s) 1850 may be a touch input device such as a keyboard, mouse, pen, or trackball, a voice input device, a scanning device, or another device that provides input to the computing environment 1800. For audio, the input device(s) 1850 may be a sound card or similar device that accepts audio input in analog or digital form, or a CD-ROM reader that provides audio samples to the computing environment. The output device(s) 1860 may be a display, printer, speaker, CD-writer, or another device that provides output from the computing environment 1800.

The communication connection(s) 1870 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Methods in Computer-Readable Media

Any of the methods described herein can be implemented by computer-executable instructions in one or more computer-readable media (e.g., computer-readable storage media or other tangible media). The technologies described herein can be implemented in a variety of programming languages.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A method comprising:
receiving an indication of a general request for online services from a mobile client device;
responsive to receiving the indication of the general request for online services, determining a set of possible specific online services associated with the general request;
determining a current context for the mobile client device, wherein the current context comprises an indication of one or more device capabilities of the mobile client device;
filtering the possible specific online services into a subset of the possible specific online services based on the current context for the mobile client device, the subset of the possible specific online services being one or more context-appropriate online services; and
sending indications of the one or more context-appropriate online services to the mobile client device for rendering at the mobile client device.

2. One or more computer-readable media comprising computer-executable instructions causing a computer to perform the method of claim 1.

3. The method of claim 1 wherein the indications of the one or more context-appropriate online services comprise an indication of an activatable user interface element to be rendered in a user interface of the mobile client device.

4. The method of claim 1 further comprising:
determining device capabilities via consulting a device capability repository.

5. The method of claim 1 wherein the indications of the one or more context-appropriate online services comprise an indication of a hyperlink by which a program can be installed at the mobile client device.

6. The method of claim 1 wherein the indications of the one or more context-appropriate online services comprise an indication of a downloadable book readable at the mobile client device.

7. The method of claim 1 wherein the indications of the one or more context-appropriate online services comprise an indication of a news story readable at the mobile client device.

8. The method of claim 1 wherein:
the current context comprises a connection mechanism type for the mobile client device; and
the filtering is based at least on the connection mechanism type for the mobile client device.

9. The method of claim 1 wherein:
the current context comprises an indication of a current location for the mobile client device; and
the filtering is based at least on the indication of the current location for the mobile client device.

10. The method of claim 1 wherein:
the current context comprises a parameter from a user profile for the mobile client device; and
the filtering is based at least on the parameter from the user profile for the mobile client device.

11. The method of claim 1 wherein:
the current context comprises an indication of a user preference for the mobile client device; and
the filtering is based at least on the indication of the user preference for the mobile client device.

12. The method of claim 1 wherein:
the possible specific online services are associated with execution requirements; and
the filtering compares the execution requirements to the current context and filters out those online services having execution requirements not appropriate for the current context.

13. The method of claim 12 wherein:
the execution requirements are stored as XML in a configuration repository, wherein an XML tag indicates a phone model capable of providing an associated online service.

14. The method of claim 12 wherein:
the execution requirements are stored in a configuration repository, wherein the configuration repository indicates whether an associated online service requires a camera.

15. The method of claim 12 wherein:
the execution requirements are stored in a configuration repository, wherein the configuration repository indicates a display resolution required by an associated online service.

16. The method of claim 1 wherein:
the device capabilities of the mobile client device are retrieved via a service oriented architecture model.

17. One or more computer-readable media having computer-executable instructions causing a computer to perform a method comprising:
receiving a general request from a mobile client device for online services available at an online portal, wherein the general request comprises a network address of the online portal;
determining a current context for the mobile client device, wherein the determining comprises determining device capabilities of the mobile client device and adding the device capabilities to the current context;
for a list of possible online services provided by the online portal, selecting only those online services appropriate for the current context, wherein the selecting comprises omitting possible online services incompatible with the device capabilities of the mobile client device as indicated by the current context and including possible online services compatible with the device capabilities of the mobile client device as indicated by the current context;
responsive to the general request, sending back a page for presentation at the mobile client device, wherein the page comprises a list of activatable indications of the online services appropriate for the current context.

18. One or more comprising computer-executable instructions encoded on one or more computer-readable media implementing a middleware service comprising:
a service requirements repository indicative of requirements for implementing services at a mobile client device;
a context engine configured to receive a general request for services, obtain capabilities of the mobile client device, and indicate a current context for the mobile client device;
a service extraction module configured to compare the requirements for implementing services against a current context for the mobile client device and filter out those services not appropriate for the current context for the mobile client device, resulting in remaining services appropriate for the current context for the mobile client device; and
a service rendering module configured to generate a renderable markup language comprising entries for the remaining services appropriate for the current context for the mobile client device.

19. The one or more computer-readable media of claim 18 wherein:
the context engine is configured to determine a context indicative of whether the user is at work; and
the service extraction module is configured to filter out online services based on the context indicative of whether the user is at work.

20. A middleware service comprising:
means for indicating requirements for implementing services at a mobile client device;
means for receiving a general request for services, obtain capabilities of the mobile client device, and indicate a current context for the mobile client device;
means for comparing the requirements for implementing services against a current context for the mobile client device and filter out those services not appropriate for the current context for the mobile client device, resulting in remaining services appropriate for the current context for the mobile client device; and
means for generating a renderable markup language comprising entries for the remaining services appropriate for the current context for the mobile client device.
